(19) United States
(12) Patent Application Publication
(10) Pub. No.: US 2025/0294467 A1
(43) Pub. Date: Sep. 18, 2025

(54) UPLINK TRANSMISSION TRANSMIT POWER DETERMINING METHOD AND APPARATUS, TERMINAL, AND NETWORK SIDE DEVICE

(71) Applicant: VIVO MOBILE COMMUNICATION CO., LTD., Dongguan (CN)

(72) Inventors: Xiaohang CHEN, Dongguan (CN); Xueming PAN, Dongguan (CN)

(73) Assignee: VIVO MOBILE COMMUNICATION CO., LTD., Dongguan (CN)

(21) Appl. No.: 19/223,927

(22) Filed: May 30, 2025

Related U.S. Application Data
(63) Continuation of application No. PCT/CN2023/133867, filed on Nov. 24, 2023.

(30) Foreign Application Priority Data
Nov. 30, 2022 (CN) 202211528967.8

(51) Int. Cl. H04W 52/14; H04W 52/24

(52) U.S. Cl. CPC H04W 52/146; H04W 52/242

(57) ABSTRACT

This application discloses an uplink transmission transmit power determining method and apparatus, a terminal, and a network side device, and pertains to the field of communication technologies. The uplink transmission transmit power determining method in embodiments of this application includes: A terminal determines a target uplink power parameter of target uplink transmission based on target information of the target uplink transmission; and the terminal determines an uplink transmit power of the target uplink transmission based on the target uplink power parameter, where the target information includes at least one of the following: a slot format; a slot type; and subband full duplex configuration information or subband full duplex indication information.

### CROSS-REFERENCE TO RELATED APPLICATIONS

This application is a continuation of International Patent Application No. PCT/CN2023/133867, filed on Nov. 24, 2023, which claims priority to Chinese Patent Application No. 202211528967.8, filed on Nov. 30, 2022 in China, both of which are incorporated herein by reference in their entireties.

### TECHNICAL FIELD

This application pertains to the field of communication technologies, and specifically relates to an uplink transmission transmit power determining method and apparatus, a terminal, and a network side device.

### BACKGROUND

With development of communication technologies, a full duplex mode is introduced in a communication system. In the full duplex mode, independent antennas are usually required to be used for sending and receiving respectively. For example, different antenna arrays or antenna panels are used for sending and receiving. Simultaneously, necessary isolation is performed between a transmit antenna and a receive antenna, to reduce mutual interference.

In a time division duplex (Time Division Duplex, TDD) mode, when a network side device performs uplink channel measurement or a terminal performs downlink channel measurement, it is usually assumed that there is reciprocity between an uplink channel and a downlink channel, thereby reducing overheads of channel measurement. In the full duplex mode, after the network side device performs specific isolation through an independent transmit antenna and an independent receive antenna, spatial characteristics may be different, and consequently the reciprocity between the uplink channel and the downlink channel cannot be ensured. In addition, when the network side device works in the full duplex mode, the network side device may switch to a half duplex mode (that is, sending only or receiving only) at some moments, and may switch back to the full duplex mode.

### SUMMARY

According to a first aspect, an uplink transmission transmit power determining method is provided. The method includes:

A terminal determines a target uplink power parameter of target uplink transmission based on target information of the target uplink transmission; and
the terminal determines an uplink transmit power of the target uplink transmission based on the target uplink power parameter, where
the target information includes at least one of the following:
a slot format;
a slot type; or
subband full duplex configuration information or subband full duplex indication information.

According to a second aspect, an uplink transmission transmit power determining method is provided. The method includes:

A network side device sends an association relationship between target information and a downlink reference signal to a terminal, or sends an uplink power parameter, where
the association relationship is used to determine a target power control parameter associated with the target information of target uplink transmission, the uplink power parameter includes the target power control parameter associated with the target information of the target uplink transmission, and the target power control parameter is used to determine an uplink transmit power of the target uplink transmission.

According to a third aspect, an uplink transmission transmit power determining apparatus is provided. The apparatus includes:
a first determining module, configured to determine a target uplink power parameter of target uplink transmission based on target information of the target uplink transmission; and
a second determining module, configured to determine an uplink transmit power of the target uplink transmission based on the target uplink power parameter, where
the target information includes at least one of the following:
a slot format;
a slot type; or
subband full duplex configuration information or subband full duplex indication information.

According to a fourth aspect, an uplink transmission transmit power determining apparatus is provided. The apparatus includes:
a sending module, configured to send an association relationship between target information and a downlink reference signal to a terminal, or send an uplink power parameter, where
the association relationship is used to determine a target power control parameter associated with the target information of target uplink transmission, the uplink power parameter includes the target power control parameter associated with the target information of the target uplink transmission, and the target power control parameter is used to determine an uplink transmit power of the target uplink transmission.

According to a fifth aspect, a terminal is provided. The terminal includes a processor and a memory, the memory stores a program or an instruction that can be run on the processor, and when the program or the instruction is executed by the processor, steps of the method according to the first aspect are implemented.

According to a sixth aspect, a terminal is provided. The terminal includes a processor and a communication interface. The processor is configured to determine a target uplink power parameter of target uplink transmission based on target information of the target uplink transmission; and determine an uplink transmit power of the target uplink transmission based on the target uplink power parameter, where the target information includes at least one of the following: a slot format; a slot type; or subband full duplex configuration information or subband full duplex indication information.

According to a seventh aspect, a network side device is provided. The network side device includes a processor and a memory, the memory stores a program or an instruction that can be run on the processor, and when the program or the instruction is executed by the processor, steps of the method according to the second aspect are implemented.

According to an eighth aspect, a network side device is provided. The network side device includes a processor and a communication interface. The communication interface is configured to send an association relationship between target information and a downlink reference signal to a terminal, or send an uplink power parameter, where the association relationship is used to determine a target power control parameter associated with the target information of target uplink transmission, the uplink power parameter includes the target power control parameter associated with the target information of the target uplink transmission, and the target power control parameter is used to determine an uplink transmit power of the target uplink transmission.

According to a ninth aspect, a communication system is provided. The communication system includes a terminal and a network side device, the terminal may be configured to perform steps of the uplink transmission transmit power determining method according to the first aspect, and the network side device may be configured to perform steps of the uplink transmission transmit power determining method according to the second aspect.

According to a tenth aspect, a readable storage medium is provided. The readable storage medium stores a program or an instruction, and when the program or the instruction is executed by a processor, steps of the method according to the first aspect are implemented, or steps of the method according to the second aspect are implemented.

According to an eleventh aspect, a chip is provided. The chip includes a processor and a communication interface, the communication interface is coupled to the processor, and the processor is configured to run a program or an instruction, to implement steps of the method according to the first aspect, or implement steps of the method according to the second aspect.

According to a twelfth aspect, a computer program/program product is provided. The computer program/program product is stored in a storage medium, and the computer program/program product is executed by at least one processor, to implement steps of the method according to the first aspect, or implement steps of the method according to the second aspect.

### BRIEF DESCRIPTION OF DRAWINGS

FIG. 1 is a schematic diagram of a network structure to which an embodiment of this application is applicable;

FIG. 2 is a flowchart of an uplink transmission transmit power determining method according to an embodiment of this application;

FIG. 3 is an example diagram of a transmission scenario of an uplink transmission transmit power determining method according to an embodiment of this application;

FIG. 4 is an example diagram of another transmission scenario of an uplink transmission transmit power determining method according to an embodiment of this application;

FIG. 5 is a flowchart of another uplink transmission transmit power determining method according to an embodiment of this application;

FIG. 6 is a structural diagram of an uplink transmission transmit power determining apparatus according to an embodiment of this application;

FIG. 7 is a structural diagram of another uplink transmission transmit power determining apparatus according to an embodiment of this application;

FIG. 8 is a structural diagram of a communication device according to an embodiment of this application;

FIG. 9 is a structural diagram of a terminal according to an embodiment of this application; and

FIG. 10 is a structural diagram of a network side device according to an embodiment of this application.

### DESCRIPTION OF EMBODIMENTS

The following clearly describes technical solutions in embodiments of this application with reference to accompanying drawings in embodiments of this application. Apparently, the described embodiments are some but not all of embodiments of this application. All other embodiments obtained by a person of ordinary skill in the art based on embodiments of this application shall fall within the protection scope of this application.

The terms “first”, “second”, and the like in this specification and the claims of this application are used to distinguish between similar objects instead of describing a specific order or sequence. It should be understood that, the terms used in such a way are interchangeable in proper circumstances, so that embodiments of this application can be implemented in an order other than the order illustrated or described herein. Objects classified by “first” and “second” are usually of a same type, and a quantity of objects is not limited. For example, there may be one or more first objects. In addition, in this specification and the claims, “and/or” represents at least one of connected objects, and the character “/” generally represents an “or” relationship between associated objects.

It should be noted that the technologies described in embodiments of this application are not limited to a long term evolution (Long Term Evolution, LTE)/LTE-advanced (LTE-Advanced, LTE-A) system, and may also be used in other wireless communication systems such as a code division multiple access (Code Division Multiple Access, CDMA) system, a time division multiple access (Time Division Multiple Access, TDMA) system, a frequency division multiple access (Frequency Division Multiple Access, FDMA) system, an orthogonal frequency division multiple access (Orthogonal Frequency Division Multiple Access, OFDMA) system, a single-carrier frequency division multiple access (Single-carrier Frequency Division Multiple Access, SC-FDMA) system, and another system. The terms “system” and “network” in embodiments of this application may be used interchangeably. The technologies described can be applied to both the systems and the radio technologies mentioned above as well as to other systems and radio technologies. A new radio (New Radio, NR) system is described in the following descriptions for illustrative purposes, and the NR terminology is used in most of the following descriptions, although these technologies can also be applied to applications other than the NR system application, for example, a 6th generation (6th Generation, 6G) communication system.

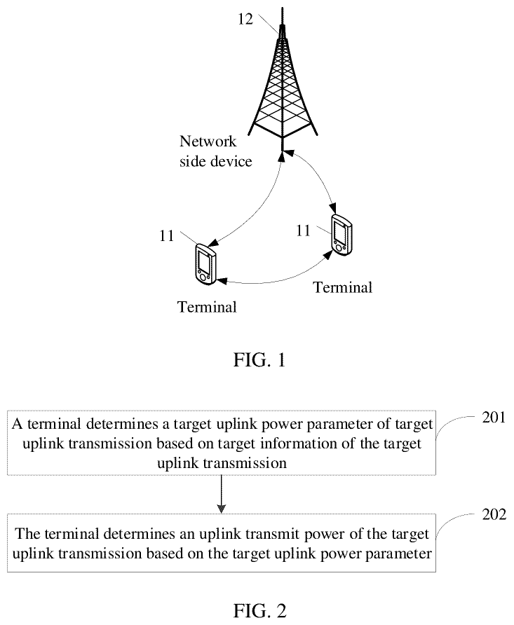

FIG. 1 is a block diagram of a wireless communication system to which embodiments of this application are applicable. The wireless communication system includes a terminal 11 and a network side device 12. The terminal 11 may be a terminal side device, for example, a mobile phone, a tablet personal computer (Tablet Personal Computer), a laptop computer (Laptop Computer) or a notebook computer, a personal digital assistant (Personal Digital Assistant, PDA), a palmtop computer, a netbook, an ultra-mobile personal computer (ultra-mobile personal computer, UMPC), a mobile internet device (Mobile Internet Device, MID), an augmented reality (augmented reality, AR)/virtual reality (virtual reality, VR) device, a robot, a wearable device (Wearable Device), vehicle user equipment (Vehicle User Equipment, VUE), pedestrian user equipment (Pedestrian User Equipment, PUE), a smart home (a home device with a wireless communication function, for example, a refrigerator, a television, a washing machine, or furniture), a game console, a personal computer (personal computer, PC), a teller machine, or a self-service machine. The wearable device includes a smart watch, a smart band, a smart headset, smart glasses, smart jewelry (a smart bangle, a smart bracelet, a smart ring, a smart necklace, a smart anklet, a smart anklet chain, or the like), a smart wrist strap, smart clothes, and the like. It should be noted that a specific type of the terminal 11 is not limited in embodiments of this application. The network side device 12 may include an access network device or a core network device. The access network device may also be referred to as a radio access network device, a radio access network (Radio Access Network, RAN), a radio access network function, or a radio access network unit. The access network device may include a base station, a wireless local area network (Wireless Local Area Network, WLAN) access point, a Wi-Fi node, or the like. The base station may be referred to as a NodeB, an evolved NodeB (eNB), an access point, a base transceiver station (Base Transceiver Station, BTS), a radio base station, a radio transceiver, a basic service set (Basic Service Set, BSS), an extended service set (Extended Service Set, ESS), a home NodeB, a home evolved NodeB, a transmit/receive point (Transmit/Receive Point, TRP), or another appropriate term in the art. The base station is not limited to a specific technical term provided that same technical effect is achieved. It should be noted that in embodiments of this application, a base station in an NR system is merely used as an example for description, and a specific type of the base station is not limited.

For ease of understanding, some content involved in embodiments of this application is described below.

### I. Unpaired Spectrum of TDD.

Different frequency domain resources on some slots/symbols of TDD may be semi-statically configured or dynamically indicated as having both uplink sending and downlink receiving.

### 2. Half Duplex Terminal.

At a same moment, the terminal can only perform uplink sending or downlink receiving. That is, at a same moment, the terminal cannot receive and send signals.

### 3. Slot Format (Slot Format).

To implement flexible network deployment, a transmission direction of each symbol in one slot is configured in a manner of a slot format in an NR system.

There are three definitions of the transmission direction of the slot in NR: downlink (Downlink, DL), uplink (Uplink, UL), and flexible (flexible). When a network side device is configured with one DL or UL slot or symbol, a transmission direction of the moment is clear. When the network side device is configured with one flexible slot or symbol, a transmission direction of the moment is to be determined. The network side device may modify the transmission direction of the flexible slot or symbol by using dynamic (dynamic) signaling, for example, a slot format indicator (slot format indicator, SFI).

One slot may include downlink (downlink), uplink (uplink), and flexible (flexible) orthogonal frequency division multiplex (Orthogonal frequency division multiplex, OFDM) symbols. The flexible symbol may be rewritten as a downlink symbol or an uplink symbol.

Optionally, the SFI may indicate a format of one or more slots (slot). The SFI is sent on a group common physical downlink control channel (Group Common Physical Downlink Control Channel, GC-PDCCH).

The SFI may flexibly change the slot format as required, to meet a service transmission requirement.

UE determines, according to an indication of the SFI, whether to monitor a PDCCH.

Optionally, the slot configuration includes the following cases:
1. The network side device may semi-statically configure one or more cell-specific (cell-specific) slot formats for the UE by using higher-layer parameters UL-DL-configuration-common and UL-DL-configuration-common-Set2 (optional).
2. The network side device may also semi-statically configure one or more UE-specific slot formats for the UE by using a higher-layer parameter UL-DL-configuration-dedicated.
3. The network side device may rewrite a flexible symbol or slot in semi-static configuration by using the SFI carried on the GC-PDCCH.
4. Sounding reference Signal (Sounding Reference Signal, SRS).

In 5th generation (5th Generation, 5G) mobile communication, according to different functions of the SRS, the SRS may be used for beam management (Beam management), codebook (Codebook) based transmission, non-codebook (non-Codebook) based transmission, and antenna switching (Antenna Switching) sending. User equipment (User Equipment, UE) may obtain a plurality of SRS resource sets (resource set) by using higher-layer signaling, and configuration of each SRS resource set includes configuration of a purpose, a periodic characteristic, or the like of the SRS resource set.

Both the SRS and a channel state information reference signal (Channel State Information Reference Signal, CSI-RS) may be used as a reference of a quasi co-location (Quasi co-location, QCL), that is, the network side device may configure a quasi co-location of another physical channel and the SRS or the CSI-RS. Both the SRS and the CSI-RS are sounding channels, but specific implementation details include the following differences:

The SRS supports a maximum of four antenna ports, and the CSI-RS supports up to 32 antenna ports; and
the SRS has a low cubic metric, so that power amplification efficiency of the terminal can be improved.

Optionally, a location of the SRS is in a comb (comb) structure, and the SRS may occupy one, two, or four consecutive OFDM symbols, but may be placed at locations of last 6 symbols of 14 symbols of one slot. SRS signals of different terminals are multiplexed on different comb offsets (offset) in frequency domain, for example, comb-2 configuration, so that multiplexing of two users can be implemented.

The network side device may configure a periodic, semi-persistent, or aperiodic SRS for the terminal. Features such as an SRS periodicity are all on a per SRS resource set (resource set) basis, in other words, all SRS attributes in one SRS resource set are the same. Use purposes of the SRS are diversified, and a behavior of specifically sending the SRS by the terminal is controlled by configuring some parameters. All parameters related to the semi-persistent SRS are configured by using higher-layer signaling (for example, radio resource control (Radio Resource Control, RRC)) configuration. After being activated by using medium access control control element (Medium Access Control Control Element, MAC CE) signaling, the terminal starts to send based on an RRC configuration parameter after specified time until the terminal receives a deactivation command from the network side device. A parameter related to the aperiodic SRS is configured by RRC, and a command is triggered in DCI to indicate the terminal to send the SRS at a single time. Two bits (bit) in the downlink control information (Downlink Control Information, DCI) indicate that the terminal is configured with a maximum of three SRS resource sets, and another state indicates inactive. An RRC configuration parameter includes a time domain parameter such as an SRS resource symbol location, a quantity of occupied symbols, frequency hopping, or a repetition (repetition) parameter R.

Optionally, determining the Slot location includes the following cases:

For the periodic SRS and the semi-persistent SRS, an SRS resource in each SRS resource set is configured with a periodic slot offset parameter, and the periodic slot offset parameter is used to determine a period and a slot offset of the SRS resource. A slot location for the SRS transmission can be determined by using the configured period and slot offset.

For the aperiodic SRS, one slot offset parameter is configured in each SRS resource set, in other words, SRS resources in the SRS resource set share one slot offset (which may occupy different symbols). A slot location for the SRS resource set transmission may be determined by using a receive slot in which the DCI that triggers the aperiodic SRS resource set is received, a subcarrier spacing between the DCI and the SRS, and a slot offset of the SRS resource set.

### 5. Configured Grant (Configured Grant, CG) Resource.

For a requirement of a low-latency service or a periodic service, NR supports two uplink semi-static scheduling grant uplink transmission (configured UL grant) manners: a type 1 (type 1) and a type 2. A configured UL grant type1 resource may be semi-statically configured by using RRC signaling. After receiving the configuration, the user performs transmission based on a service arrival status and a configuration status of the user, and the DCI does not need to be dynamically scheduled. A configured UL grant type2 resource may be semi-statically configured by using RRC signaling. After receiving the configuration, the user cannot directly use the configured UL grant type2 resource. The user can use the grant resource based on the activated DCI only after the network side device further activates the configuration by using the DCI. The network side device may also deactivate the configuration by using the DCI, and the user receiving the deactivated DCI stops the grant resource.

### 6. Random Access Channel (Random Access Channel, RACH) Resource Configuration.

In time domain, an index (Configuration Index) is configured through a physical random access channel (Physical Random Access Channel, PRACH), and the network side device indicates a specific PRACH format used by the UE and specific locations at which a preamble (Preamble) may be sent.

For a long preamble (formats 0 to 3), the UE mainly needs to know specific subframes (subframe) of specific system frames (system frame) in which the preamble (where a start symbol of the long preamble is usually 0, and in a few cases, is 7) can be sent.

For a short preamble (formats A1, A2, A3, B1, B2, B3, B4, C0, and C2), the UE further needs to know specific symbols (symbol) of specific slots (slot) in which the preamble can be sent.

Currently, the terminal determines an uplink transmission transmit power based on uplink power control configuration configured by the network. A parameter for uplink power control in uplink channel transmission, for example, a target transmit power or a downlink reference signal used to estimate a path loss, is also configured by the network side device. In a full duplex mode, after the network side device performs specific isolation through an independent transmit antenna and an independent receive antenna, and consequently reciprocity between an uplink channel and a downlink channel cannot be ensured. Simultaneously, switching between the full duplex mode and a half duplex mode may require a corresponding change in antenna configuration of the network side device, thereby reducing reliability of uplink transmission. Therefore, an uplink transmission transmit power determining method in this application is proposed.

Embodiments of this application provide an uplink transmission transmit power determining method and apparatus, a terminal, and a network side device, so that a problem that performance of uplink transmission decreases due to switching between a full duplex mode and a half duplex mode.

In embodiments of this application, the terminal determines the target uplink power parameter of the target uplink transmission based on the target information of the target uplink transmission; and the terminal determines the uplink transmit power of the target uplink transmission based on the target uplink power parameter, where the target information includes at least one of the following: the slot format; the slot type; or the subband full duplex configuration information or the subband full duplex indication information. In this way, when the network side device switches antenna configuration, uplink transmission may be performed by using an uplink transmit power corresponding to a spatial characteristic applicable to the current antenna configuration. Therefore, reliability of the uplink transmission is improved in embodiments of this application.

With reference to the accompanying drawings, the following describes in detail the uplink transmission transmit power determining method provided in embodiments of this application by using some embodiments and application scenarios thereof.

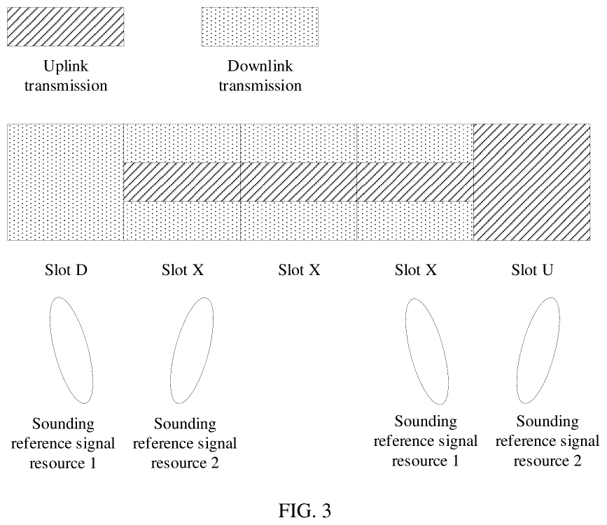

Refer to FIG. 2. An embodiment of this application provides an uplink transmission transmit power determining method. As shown in FIG. 2, the uplink transmission transmit power determining method includes the following steps:
Step 201: A terminal determines a target uplink power parameter of target uplink transmission based on target information of the target uplink transmission.
Step 202: The terminal determines an uplink transmit power of the target uplink transmission based on the target uplink power parameter.

The target information includes at least one of the following: a slot format; a slot type; or subband full duplex configuration information or subband full duplex indication information.

In this embodiment of this application, the target uplink transmission may include at least one of the following: physical uplink shared channel (Physical Uplink Shared Channel, PUSCH) transmission, physical uplink control channel (Physical Uplink Control Channel, PUCCH) transmission, sounding reference signal (Sounding Reference Signal, SRS) transmission, or physical random access channel (Physical Random Access Channel, PRACH) transmission.

Optionally, a time domain type may include:
an uplink (UL), configured for an uplink time domain unit;
a downlink (DL), configured for a downlink time domain unit; and
full duplex/flexible duplex, which may be used in DL, UL, and/or flexible time domain units, where a specific type may include subband full duplex (subband full duplex, SBFD).

Optionally, a time domain format or the time domain type may be indicated by time division duplex uplink/downlink configuration (TDD-UL-DL-Configuration), frequency division duplex uplink/downlink configuration (FDD-UL-DL-Configuration), flexible duplex uplink/downlink configuration (XDD-UL-DL-Configuration), or the like; and may be configured at a network higher layer, for example, configured by using terminal-specific signaling or configured by using broadcast signaling.

Full duplex subband configuration information or full duplex subband indication information may be used to indicate a full duplex frequency domain UL subband format, a full duplex frequency domain DL subband format, a guard band (Guard band), a downlink (Downlink, DL) bandwidth part (Bandwidth Part, BWP), and an uplink bandwidth part (UL BWP).

Optionally, a corresponding spatial characteristic may be determined based on the target information, so that the target uplink power parameter is determined based on the spatial characteristic corresponding to the target information, and the uplink transmit power is further determined based on the determined target uplink power parameter. In this way, when a network side device switches antenna configuration, uplink transmission may be performed by using an uplink transmit power of a spatial characteristic applicable to the current antenna configuration.

It should be noted that transmission in embodiments of this application may be understood as sending and/or receiving.

In this embodiment of this application, the terminal determines the target uplink power parameter of the target uplink transmission based on the target information of the target uplink transmission; and the terminal determines the uplink transmit power of the target uplink transmission based on the target uplink power parameter, where the target information includes at least one of the following: the slot format; the slot type; or the subband full duplex configuration information or the subband full duplex indication information. In this way, when the network side device switches the antenna configuration, uplink transmission may be performed by using the uplink transmit power corresponding to the spatial characteristic applicable to the current antenna configuration. Therefore, reliability of the uplink transmission is improved in this embodiment of this application.

Optionally, in some embodiments, that a terminal determines a target uplink power parameter of target uplink transmission based on target information of the target uplink transmission includes:

The terminal determines an uplink power parameter corresponding to a target spatial characteristic as the target uplink power parameter, where the target spatial characteristic is determined based on the target information of the target uplink transmission.

In this embodiment of this application, when sending the target uplink transmission, the terminal may first determine the target spatial characteristic based on the target information of the current target uplink transmission, and then determine, based on a correspondence between a spatial characteristic and an uplink power parameter, the target uplink power parameter associated with the target spatial characteristic, so that after determining the uplink transmit power, the terminal sends the target uplink transmission based on the determined uplink transmit power. Alternatively, when the target uplink transmission that currently needs to be sent is associated with a plurality of different spatial characteristics, the target uplink transmission that currently needs to be sent may be sent by using the target spatial characteristic.

For example, a transmit/receive antenna of the network side device on a time domain resource n (where the time domain resource n has a specific time domain format Y) is configured as A, and a spatial characteristic corresponding to the antenna configuration A is S. UE obtains an uplink power control parameter K based on the spatial characteristic S, and determines an uplink transmission transmit power on the time domain resource n.

Optionally, in some embodiments, the target spatial characteristic includes at least one of the following:
an associated synchronization signal block;
an associated channel state information reference signal;
an associated sounding reference signal;
a spatial relationship; or
transmission configuration indication state or quasi-co-location.

Optionally, in a case that the target uplink power parameter includes a downlink reference signal used to estimate a path loss, different values of the target information are associated with different downlink reference signals, and that a terminal determines a target uplink power parameter of target uplink transmission based on target information of the target uplink transmission includes:

The terminal determines, based on an association relationship between the target information and the downlink reference signal, a target downlink reference signal associated with the target information of the target uplink transmission, where
the target downlink reference signal is a path loss parameter in the target uplink power parameter.

In this embodiment of this application, the terminal may perform path loss estimation based on the target downlink reference signal to obtain a path loss; and the terminal determines an uplink transmit power of the target uplink transmission based on the path loss.

Optionally, the association relationship is protocol-stipulated or configured by a network side device. Different downlink reference signals may be associated with different target information.

In some embodiments, the foregoing association relationship may be determined according to a predefined rule. For example, a number (in ascending or descending order) of the downlink reference signal used to estimate the path loss is associated with a time unit whose time domain format (in a specific time window or at a specific moment) is DL/Flexible, whose time domain type is DL/SBFD X, and in which full duplex frequency domain DL subband format takes effect.

In some embodiments, the association relationship may be configured by the network side device. For example, at least one of the following may be configured:
a downlink reference signal k used to estimate the path loss is associated with a time unit whose time domain type (in a specific time window or at a specific moment) is DL; or
a downlink reference signal n used to estimate the path loss is associated with a time unit whose time domain type (in a specific time window or at a specific moment) is SBFD X.

Optionally, in some embodiments, the time unit may be a time unit corresponding to a specific time window or a specific moment, and the specific time window and the specific moment may be configured by the network side device, or determined by the terminal based on other configuration information.

Optionally, in some embodiments, the downlink reference signal includes at least one of the following: a synchronization signal block (Synchronization Signal Block, SSB), a channel state information reference signal CSI-RS, or a downlink reference signal associated with an SRS.

Optionally, in some embodiments, that a terminal determines a target uplink power parameter of target uplink transmission based on target information of the target uplink transmission includes:

The terminal receives an uplink power parameter from a network side device; and
the terminal determines, based on the target information of the target uplink transmission, the target uplink power parameter, in the uplink power parameter, that corresponds to the target uplink transmission.

In this embodiment of this application, the network side device may indicate the uplink power parameter, so that the uplink transmit power corresponding to the current antenna configuration may be determined based on the uplink power parameter indicated by the network side device, thereby improving reliability of the uplink transmission.

For example, the network side device may indicate a plurality of sets of different uplink power parameters, and each set of uplink power parameters may be associated with different target information. In this case, the terminal may determine, based on the target information of the target uplink transmission, the target uplink power parameter corresponding to the target uplink transmission.

Optionally, in some embodiments, in a case that the target uplink power parameter includes a downlink reference signal used to estimate a path loss, before that the terminal receives an uplink power parameter from a network side device, the method further includes:

The terminal receives indication information from the network side device, where the indication information is used to indicate a resource of the downlink reference signal and the target information corresponding to the resource of the downlink reference signal.

In this embodiment of this application, the downlink reference signal may be a CSI-RS, and the terminal may select a corresponding downlink reference signal for measurement based on the target information, thereby obtaining the path loss, and determining the uplink transmit power based on the path loss.

Optionally, the indication information is carried by group common downlink control information DCI or scheduling DCI.

Optionally, the indication information is used for any one of the following:
the target uplink transmission in a target period;
the target uplink transmission in a next period of a target period;
the target uplink transmission in a target period and at least one period after the target period; or
the target uplink transmission in at least one period after a target period, where
the target period is a period in which a moment at which the indication information is received is located.

Optionally, in some embodiments, in a case that the target uplink transmission includes transmission of a random access message, that a terminal determines a target uplink power parameter of target uplink transmission based on target information of the target uplink transmission includes:
The terminal determines, based on the target information of the target uplink transmission, whether to perform a power ramping operation based on the target information of the target uplink transmission; and
in a case that it is determined that the power ramping (Power ramping) operation is performed based on the target information of the target uplink transmission, the terminal determines the target uplink power parameter of the target uplink transmission based on the target information of the target uplink transmission.

Optionally, the random access message may include a PRACH/messageA (msgA) PUSCH.

It should be understood that in a random access process, a success rate of random access can be improved by power ramping. In this embodiment of this application, the terminal determines, based on the target information of the target uplink transmission, whether to perform the power ramping operation based on the target information of the target uplink transmission in this embodiment of this application. For example, in a case that target information of two adjacent times of target uplink transmission does not change, according to the solution of the related technology, power ramping may be directly performed on a power of a previous time of target uplink transmission based on a preset power ramping step. In a case that the target information of the two adjacent times of target uplink transmission changes, the power ramping operation may be performed based on the target information of the target uplink transmission. In this way, accuracy of power ramping is improved, thereby further improving reliability of the uplink transmission.

For example, in some embodiments, the path loss may be estimated by using the corresponding downlink reference signal based on target information of a time domain resource for PRACH/msgA PUSCH transmission on which power ramping needs to be performed, and the transmit power of the uplink transmission may be determined. In some embodiments, the downlink reference signal used to estimate the path loss of the PRACH/msgA PUSCH on which power ramping is performed can also be determined based on the downlink reference signal used to estimate the path loss corresponding to specific target information indicated by the network side device, the path loss can be estimated using the corresponding downlink reference signal, and the transmit power of the uplink transmission can be determined.

Optionally, in some embodiments, that the terminal determines the uplink transmit power of the target uplink transmission based on the target uplink power parameter includes:

The terminal determines the uplink transmit power of the target uplink transmission based on the target uplink power parameter and a power offset configured by the network side device.

In this embodiment of this application, in a case that it is determined that the power ramping operation is performed based on the target information of the target uplink transmission, a behavior of the power ramping operation may meet at least one of the following:
In a case that it is determined that the power ramping operation is performed based on the target information of the target uplink transmission, and the target uplink power parameter of the current target uplink transmission and a number of a downlink reference signal included in a target uplink power parameter of a previous time of target uplink transmission change, the terminal determines the uplink transmit power of the target uplink transmission based on the target uplink power parameter and the power offset configured by the network side device; or
in a case that it is determined that the power ramping operation is performed based on the target information of the target uplink transmission, and the target uplink power parameter of the current target uplink transmission and a spatial characteristic of a downlink reference signal included in a target uplink power parameter of a previous time of target uplink transmission change, the terminal determines the uplink transmit power of the target uplink transmission based on the target uplink power parameter and the power offset configured by the network side device.

That is, the power offset may indicate that the power needs to be adjusted when the number of the downlink reference signal changes or the spatial characteristic of the downlink reference signal changes.

Optionally, in some embodiments, the target uplink power parameter includes at least one of the following power control parameters:
a target received power, namely, a received power expected to be received by the network side device;
a path loss parameter, where the path loss parameter includes a downlink reference signal;
a power control loop;
a transmit power control command;
a power compensation factor; or
a power ramping step.

In this embodiment of this application, the target received power of the network side device may be referred to as P0.

To better understand this application, some examples are used for detailed description below.

Optionally, in some embodiments, as shown in FIG. 3, it is assumed that the slot format is configured as DXXXU.

For the network side device, a panel 1 (Panel 1) and a panel 2 may be used for downlink transmission in a downlink slot (namely, a slot D), the panel 1 may also be used for downlink transmission in a flexible slot (namely, a slot X), the panel 2 may also be used for uplink receiving in a slot X, and the panel 1 may also be used for uplink receiving in an uplink slot (namely, a slot U). Assuming that a spatial characteristic of a CSI-RS resource 1 associated with the panel 1 and the panel 2 is a QCL 1, and a spatial characteristic of a CSI-RS resource 2 associated with the panel 1 is a QCL 2. The CSI-RS resource 1 is configured to be associated with an uplink power control parameter 1 (UL power control 1), and the CSI-RS resource 2 is configured to be associated with an uplink power control parameter 2 (UL power control 2).

In this case, that the terminal estimates the path loss by using the corresponding downlink reference signal and based on the slot type, to determine an uplink receiving transmit power includes the following cases:
Based on the UL power control 1, the path loss is estimated based on the CSI-RS 1 in the slot D, to determine the uplink transmit power of the PUSCH 1; and
based on the UL power control 2, the path loss is estimated based on the CSI-RS 2 in the slot X, to determine the uplink transmit power of the PUSCH 2, where
the CSI-RS 1 is a downlink reference signal on the CSI-RS resource 1, and the CSI-RS 2 is a downlink reference signal on the CSI-RS resource 2.

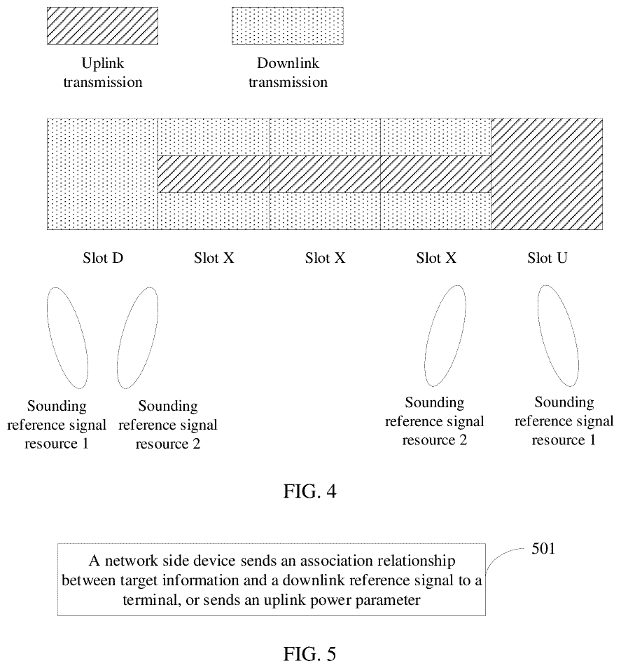

Optionally, in some embodiments, as shown in FIG. 4, it is assumed that the slot format is configured as DXXXU.

For the network side device, a panel 1 (Panel 1) and a panel 2 may be used for downlink transmission in a downlink slot (namely, a slot D), the panel 1 may also be used for downlink transmission in a flexible slot (namely, a slot X), the panel 2 may also be used for uplink receiving in a slot X, and the panel 1 and the panel 2 may also be used for uplink receiving in an uplink slot (namely, a slot U). Assuming that a spatial characteristic of a CSI-RS resource 1 associated with the panel 1 and the panel 2 is a QCL 1, and a spatial characteristic of a CSI-RS resource 2 associated with panel the panel 2 is a QCL 2. The CSI-RS resource 1 is configured to be associated with an uplink power control parameter 1 (UL power control 1), and the CSI-RS resource 2 is configured to be associated with an uplink power control parameter 2.

In this case, that the terminal estimates the path loss by using the corresponding downlink reference signal and based on the slot type, to determine an uplink receiving transmit power includes the following cases:
Based on the UL power control 1, the path loss is estimated based on the CSI-RS 1 in the slot D, to determine the uplink transmit power of the PUSCH 1; and
based on the UL power control 2, the path loss is estimated based on the CSI-RS 2 in the slot X, to determine the uplink transmit power of the PUSCH 2, where
the CSI-RS 1 is a downlink reference signal on the CSI-RS resource 1, and the CSI-RS 2 is a downlink reference signal on the CSI-RS resource 2.

It should be noted that the slot X includes a full duplex frequency domain uplink subband and a full duplex frequency domain downlink subband. Specifically, manners of division into subbands include but are not limited to manners of division shown in FIG. 3 and FIG. 4.

Refer to FIG. 5. An embodiment of this application provides an uplink transmission transmit power determining method. As shown in FIG. 5, the uplink transmission transmit power determining method includes the following steps:
Step 501: A network side device sends an association relationship between target information and a downlink reference signal to a terminal, or sends an uplink power parameter, where
the association relationship is used to determine a target power control parameter associated with the target information of target uplink transmission, an uplink power control parameter includes the target power control parameter associated with the target information of the target uplink transmission, and the target power control parameter is used to determine an uplink transmit power of the target uplink transmission.

Optionally, a target spatial characteristic corresponding to a target uplink power parameter is determined based on the target information of the target uplink transmission.

Optionally, the target spatial characteristic includes at least one of the following:
an associated synchronization signal block;
an associated channel state information reference signal;
an associated sounding reference signal;
a spatial relationship; or
transmission configuration indication state or quasi-co-location.

Optionally, the target uplink transmission includes any one of the following:
physical uplink shared channel PUSCH transmission, physical uplink control channel PUCCH transmission, sounding reference signal SRS transmission, and physical random access channel PRACH transmission.

Optionally, the downlink reference signal includes at least one of the following: a synchronization signal block SSB, a channel state information reference signal CSI-RS, or a downlink reference signal associated with an SRS.

Optionally, in a case that a target uplink power parameter includes a downlink reference signal used to estimate a path loss, before that a network side device sends an uplink power parameter to a terminal, the method further includes:

The network side device sends indication information to the terminal, where the indication information is used to indicate a resource of the downlink reference signal and the target information corresponding to the resource of the downlink reference signal.

Optionally, the indication information is carried by group common downlink control information DCI or scheduling DCI.

Optionally, the indication information is used for any one of the following:
the target uplink transmission in a target period;
the target uplink transmission in a next period of a target period;
the target uplink transmission in a target period and at least one period after the target period; or
the target uplink transmission in at least one period after a target period, where
the target period is a period in which a moment at which the indication information is received is located.

Optionally, the target uplink power parameter includes at least one of the following power control parameters:
a target received power of the network side device;
a path loss parameter, where the path loss parameter includes a downlink reference signal;
a power control loop;
a transmit power control command;
a power compensation factor; or
a power ramping step.

The uplink transmission transmit power determining method provided in embodiments of this application may be performed by an uplink transmission transmit power determining apparatus. In embodiments of this application, an example in which the uplink transmission transmit power determining apparatus performs the uplink transmission transmit power determining method is used, to describe the uplink transmission transmit power determining apparatus provided in embodiments of this application.

In the embodiments, the uplink power parameter is the same as the uplink power control parameter.

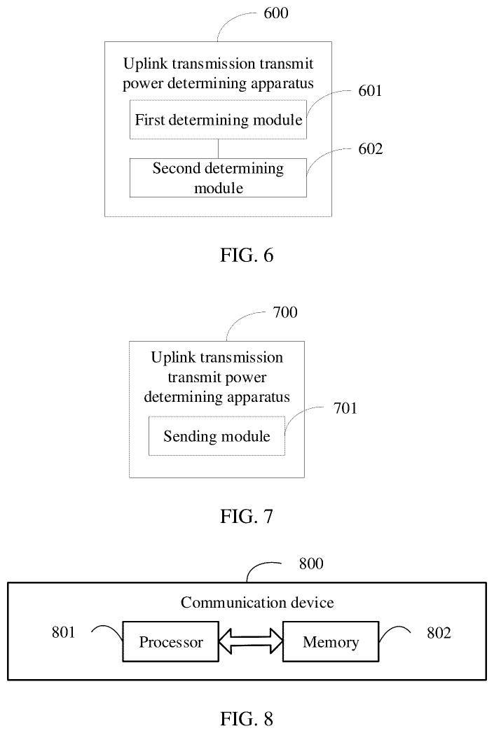

Refer to FIG. 6. An embodiment of this application further provides an uplink transmission transmit power determining apparatus. As shown in FIG. 6, the uplink transmission transmit power determining apparatus 600 includes:
a first determining module 601, configured to determine a target uplink power parameter of target uplink transmission based on target information of the target uplink transmission; and
a second determining module 602, configured to determine an uplink transmit power of the target uplink transmission based on the target uplink power parameter, where
the target information includes at least one of the following:
a slot format;
a slot type; or
subband full duplex configuration information or subband full duplex indication information.

Optionally, the first determining module 601 is specifically configured to determine an uplink power parameter corresponding to a target spatial characteristic as the target uplink power parameter, where the target spatial characteristic is determined based on the target information of the target uplink transmission.

Optionally, the target spatial characteristic includes at least one of the following:
an associated synchronization signal block;
an associated channel state information reference signal;
an associated sounding reference signal;
a spatial relationship; or
transmission configuration indication state or quasi-co-location.

Optionally, the target uplink transmission includes any one of the following:
physical uplink shared channel PUSCH transmission, physical uplink control channel PUCCH transmission, sounding reference signal SRS transmission, and physical random access channel PRACH transmission.

Optionally, in a case that the target uplink power parameter includes a downlink reference signal used to estimate a path loss, the first determining module 601 is specifically configured to determine, based on an association relationship between the target information and the downlink reference signal, a target downlink reference signal associated with the target information of the target uplink transmission, where
the target downlink reference signal is a path loss parameter in the target uplink power parameter.

Optionally, the association relationship is protocol-stipulated or configured by a network side device.

Optionally, the downlink reference signal includes at least one of the following: a synchronization signal block SSB, a channel state information reference signal CSI-RS, or a downlink reference signal associated with an SRS.

Optionally, the first determining module 601 includes:
a receiving unit, configured to receive an uplink power parameter from a network side device; and
a determining unit, configured to determine, based on the target information of the target uplink transmission, the target uplink power parameter, in the uplink power parameter, that corresponds to the target uplink transmission.

Optionally, in a case that the target uplink power parameter includes a downlink reference signal used to estimate a path loss, the receiving unit is further configured to receive indication information from the network side device, where the indication information is used to indicate a resource of the downlink reference signal and the target information corresponding to the resource of the downlink reference signal.

Optionally, the indication information is carried by group common downlink control information DCI or scheduling DCI.

Optionally, the indication information is used for any one of the following:
the target uplink transmission in a target period;
the target uplink transmission in a next period of a target period;
the target uplink transmission in a target period and at least one period after the target period; or
the target uplink transmission in at least one period after a target period, where
the target period is a period in which a moment at which the indication information is received is located.

Optionally, in a case that the target uplink transmission includes transmission of a random access message, the first determining module 601 is specifically configured to: determine, based on the target information of the target uplink transmission, whether to perform a power ramping operation based on the target information of the target uplink transmission; and in a case that it is determined that the power ramping operation is performed based on the target information of the target uplink transmission, determine the target uplink power parameter of the target uplink transmission based on the target information of the target uplink transmission.

Optionally, the second determining module 602 is specifically configured to determine the uplink transmit power of the target uplink transmission based on the target uplink power parameter and a power offset configured by the network side device.

Optionally, the target uplink power parameter includes at least one of the following power control parameters:
a target received power of the network side device;
a path loss parameter, where the path loss parameter includes a downlink reference signal;
a power control loop;
a transmit power control command;
a power compensation factor; or
a power ramping step.

Refer to FIG. 7. An embodiment of this application further provides an uplink transmission transmit power determining apparatus. As shown in FIG. 7, the uplink transmission transmit power determining apparatus 700 includes:
a sending module 701, configured to send an association relationship between target information and a downlink reference signal to a terminal, or send an uplink power parameter, where
the association relationship is used to determine a target power control parameter associated with the target information of target uplink transmission, an uplink power control parameter includes the target power control parameter associated with the target information of the target uplink transmission, and the target power control parameter is used to determine an uplink transmit power of the target uplink transmission.

Optionally, a target spatial characteristic corresponding to a target uplink power parameter is determined based on the target information of the target uplink transmission.

Optionally, the target spatial characteristic includes at least one of the following:
an associated synchronization signal block;
an associated channel state information reference signal;
an associated sounding reference signal;
a spatial relationship; or
transmission configuration indication state or quasi-co-location.

Optionally, the target uplink transmission includes any one of the following:
physical uplink shared channel PUSCH transmission, physical uplink control channel PUCCH transmission, sounding reference signal SRS transmission, and physical random access channel PRACH transmission.

Optionally, the downlink reference signal includes at least one of the following: a synchronization signal block SSB, a channel state information reference signal CSI-RS, or a downlink reference signal associated with an SRS.

Optionally, in a case that the target uplink power parameter includes a downlink reference signal used to estimate a path loss, the sending module 701 is further configured to receive indication information from the network side device, where the indication information is used to indicate a resource of the downlink reference signal and the target information corresponding to the resource of the downlink reference signal.

Optionally, the indication information is carried by group common downlink control information DCI or scheduling DCI.

Optionally, the indication information is used for any one of the following:
the target uplink transmission in a target period;
the target uplink transmission in a next period of a target period;
the target uplink transmission in a target period and at least one period after the target period; or
the target uplink transmission in at least one period after a target period, where
the target period is a period in which a moment at which the indication information is received is located.

Optionally, the target uplink power parameter includes at least one of the following power control parameters:
a target received power of the network side device;
a path loss parameter, where the path loss parameter includes a downlink reference signal;
a power control loop;
a transmit power control command;
a power compensation factor; or
a power ramping step.

The uplink transmission transmit power determining apparatus in this embodiment of this application may be an electronic device, for example, an electronic device with an operating system, or may be a component, for example, an integrated circuit or a chip, in the electronic device. The electronic device may be a terminal, or may be a device other than the terminal. For example, the terminal may include but is not limited to the foregoing listed types of the terminal 11. The another device may be a server, a network attached storage (Network Attached Storage, NAS), or the like. This is not specifically limited in this embodiment of this application.

The uplink transmission transmit power determining apparatus provided in this embodiment of this application can implement processes of the method embodiments in FIG. 2 to FIG. 5, and same technical effect can be achieved. To avoid duplication, details are not described herein again.

Optionally, as shown in FIG. 8, an embodiment of this application further provides a communication device 800. The communication device 800 includes a processor 801 and a memory 802, and the memory 802 stores a program or an instruction that can be run on the processor 801. When the program or the instruction is executed by the processor 801, steps of the embodiment of the uplink transmission transmit power determining method are implemented, and same technical effect can be achieved. To avoid repetition, details are not described herein again.

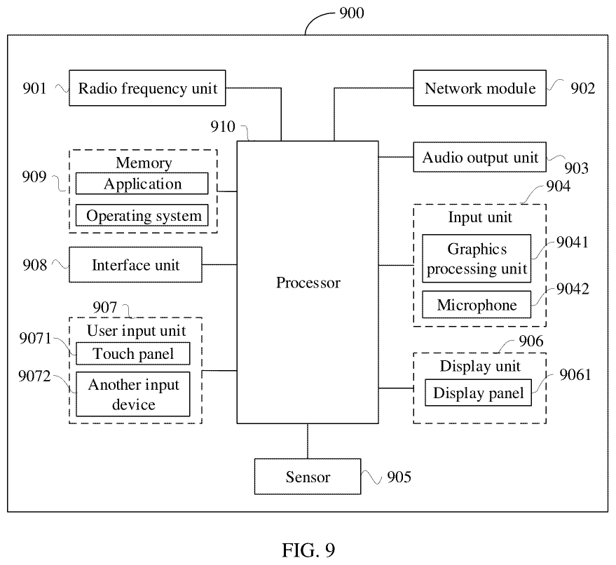

An embodiment of this application further provides a terminal. The terminal includes a processor and a communication interface. The processor is configured to determine a target uplink power parameter of target uplink transmission based on target information of the target uplink transmission; and determine an uplink transmit power of the target uplink transmission based on the target uplink power parameter, where the target information includes at least one of the following: a slot format; a slot type; or subband full duplex configuration information or subband full duplex indication information. The terminal embodiment corresponds to the method embodiment on the terminal side, each implementation process and implementation of the method embodiment can be applied to the terminal embodiment, and same technical effect can be achieved. Specifically, FIG. 9 is a schematic diagram of a hardware structure of a terminal according to an embodiment of this application.

The terminal 900 includes but is not limited to at least a part of components such as a radio frequency unit 901, a network module 902, an audio output unit 903, an input unit 904, a sensor 905, a display unit 906, a user input unit 907, an interface unit 908, a memory 909, or a processor 910.

A person skilled in the art can understand that the terminal 900 may further include a power supply (such as a battery) that supplies power to each component. The power supply may be logically connected to the processor 910 by using a power supply management system, to implement functions such as charging and discharging management, and power consumption management by using the power supply management system. The structure of the terminal shown in FIG. 9 constitutes no limitation on the terminal, and the terminal may include more or fewer components than those shown in the figure, or combine some components, or have different component arrangements. Details are not described herein.

It should be understood that in this embodiment of this application, the input unit 904 may include a graphics processing unit (Graphics Processing Unit, GPU) 9041 and a microphone 9042. The graphics processing unit 9041 processes image data of a static picture or a video obtained by an image capture apparatus (for example, a camera) in a video capture mode or an image capture mode. The display unit 906 may include a display panel 9061, and the display panel 9061 may be configured in a form of a liquid crystal display, an organic light-emitting diode, or the like. The user input unit 907 includes at least one of a touch panel 9071 or another input device 9072. The touch panel 9071 is also referred to as a touchscreen. The touch panel 9071 may include two parts: a touch detection apparatus and a touch controller. The another input device 9072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 901 may transmit the downlink data to the processor 910 for processing. In addition, the radio frequency unit 901 may send uplink data to the network side device. Usually, the radio frequency unit 901 includes but is not limited to an antenna, an amplifier, a transceiver, a coupler, a low noise amplifier, a duplexer, and the like.

The memory 909 may be configured to store a software program or an instruction and various data. The memory 909 may mainly include a first storage area for storing a program or an instruction and a second storage area for storing data. The first storage area may store an operating system, and an application or an instruction required by at least one function (for example, a sound playing function or an image playing function). In addition, the memory 909 may be a volatile memory or a non-volatile memory, or the memory 909 may include a volatile memory and a non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synch link dynamic random access memory (Synch link DRAM, SLDRAM), and a direct rambus random access memory (Direct Rambus RAM, DRRAM). The memory 909 in this embodiment of this application includes but is not limited to these memories and any memory of another proper type.

The processor 910 may include one or more processing units. Optionally, an application processor and a modem processor are integrated into the processor 910. The application processor mainly processes an operating system, a user interface, an application, and the like. The modem processor mainly processes a wireless communication signal, for example, a baseband processor. It may be understood that, alternatively, the modem processor may not be integrated into the processor 910.

The processor 910 is configured to: determine a target uplink power parameter of target uplink transmission based on target information of the target uplink transmission; and determine an uplink transmit power of the target uplink transmission based on the target uplink power parameter, where the target information includes at least one of the following: a slot format; a slot type; or subband full duplex configuration information or subband full duplex indication information.

An embodiment of this application further provides a network side device. The network side device includes a processor and a communication interface. The communication interface is configured to send an association relationship between target information and a downlink reference signal to a terminal, or send an uplink power parameter, where the association relationship is used to determine a target power control parameter associated with the target information of target uplink transmission, an uplink power control parameter includes the target power control parameter associated with the target information of the target uplink transmission, and the target power control parameter is used to determine an uplink transmit power of the target uplink transmission. The network side device embodiment corresponds to the method embodiment of the network side device, each implementation process and implementation of the method embodiment can be applied to the network side device embodiment, and same technical effect can be achieved.

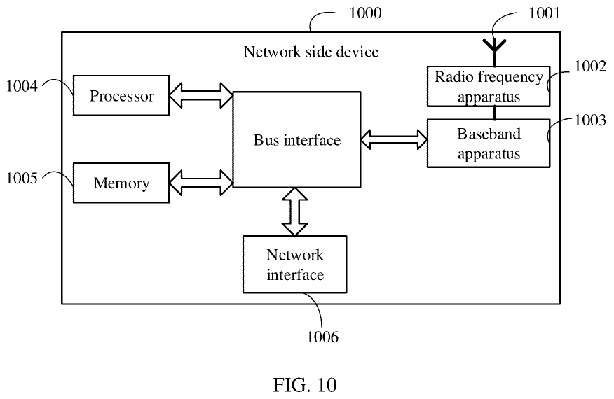

Specifically, an embodiment of this application further provides a network side device. As shown in FIG. 10, the network side device 1000 includes an antenna 1001, a radio frequency apparatus 1002, a baseband apparatus 1003, a processor 1004, and a memory 1005. The antenna 1001 is connected to the radio frequency apparatus 1002. In an uplink direction, the radio frequency apparatus 1002 receives information through the antenna 1001, and sends the received information to the baseband apparatus 1003 for processing. In a downlink direction, the baseband apparatus 1003 processes information that needs to be sent, and sends processed information to the radio frequency apparatus 1002. The radio frequency apparatus 1002 processes the received information, and sends processed information through the antenna 1001.

In the foregoing embodiment, the method performed by the network side device may be implemented in the baseband apparatus 1003. The baseband apparatus 1003 includes a baseband processor.

For example, the baseband apparatus 1003 may include at least one baseband board. A plurality of chips are disposed on the baseband board. As shown in FIG. 10, one chip is, for example, a baseband processor, and is connected to the memory 1005 through a bus interface, to invoke a program in the memory 1005 to perform the operations of the network side device shown in the method embodiment.

The network side device may further include a network interface 1006, and the interface is, for example, a common public radio interface (common public radio interface, CPRI).

Specifically, the network side device 1000 in this embodiment of the present invention further includes an instruction or a program that is stored in the memory 1005 and that can be run on the processor 1004. The processor 1004 invokes the instruction or the program in the memory 1005 to perform the method performed by the modules shown in FIG. 7, and same technical effect is achieved. To avoid repetition, details are not described herein.

An embodiment of this application further provides a readable storage medium. The readable storage medium stores a program or an instruction, and when the program or the instruction is executed by a processor, processes of the embodiment of the uplink transmission transmit power determining method are implemented, and same technical effect can be achieved. To avoid repetition, details are not described herein again.

The processor is a processor in the terminal in the foregoing embodiments. The readable storage medium includes a computer-readable storage medium, for example, a computer read-only memory ROM, a random access memory RAM, a magnetic disk, or an optical disc.

An embodiment of this application further provides a chip. The chip includes a processor and a communication interface, the communication interface is coupled to the processor, the processor is configured to run a program or an instruction, to implement processes of the embodiment of the uplink transmission transmit power determining method, and same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product. The computer program/program product is stored in a storage medium, the computer program/program product is executed by at least one processor, to implement processes of the embodiment of the uplink transmission transmit power determining method, and same technical effect can be achieved. To avoid repetition, details are not described herein again.

An embodiment of this application further provides a communication system. The communication system includes a terminal and a network side device. The terminal is configured to perform processes in the method embodiments on the terminal side in FIG. 2, the network side device is configured to perform processes in the method embodiments on the network side device side in FIG. 5, and same technical effect can be achieved. To avoid repetition, details are not described herein again.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in embodiments of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiments may be implemented by software in addition to a necessary universal hardware platform or by hardware only. In most circumstances, the former is a preferred implementation. Based on such an understanding, the technical solutions of this application essentially or the part contributing to the prior art may be implemented in a form of a computer software product. The computer software product is stored in a storage medium (for example, a ROM/RAM, a magnetic disk, or an optical disc), and includes several instructions for instructing a terminal (which may be a mobile phone, a computer, a server, an air conditioner, a network device, or the like) to perform the method described in embodiments of this application.

Embodiments of this application are described above with reference to the accompanying drawings. However, this application is not limited to the foregoing specific implementations. The foregoing specific implementations are merely examples, but are not limitative. Under the enlightenment of this application, a person of ordinary skill in the art May further make many forms without departing from the purpose of this application and the protection scope of the claims, and all the forms fall within the protection of this application.

1. An uplink transmission transmit power determining method, comprising:
determining, by a terminal, a target uplink power parameter of target uplink transmission based on target information of the target uplink transmission; and
determining, by the terminal, an uplink transmit power of the target uplink transmission based on the target uplink power parameter, wherein
the target information comprises at least one of the following:
a slot format;
a slot type; or
subband full duplex configuration information or subband full duplex indication information.

2. The method according to claim 1, wherein the determining, by a terminal, a target uplink power parameter of target uplink transmission based on target information of the target uplink transmission comprises:
determining, by the terminal, an uplink power parameter corresponding to a target spatial characteristic as the target uplink power parameter, wherein the target spatial characteristic is determined based on the target information of the target uplink transmission.

3. The method according to claim 2, wherein the target spatial characteristic comprises at least one of the following:
an associated synchronization signal block;
an associated channel state information reference signal;
an associated sounding reference signal;
a spatial relationship; or
transmission configuration indication state or quasi-co-location.

4. The method according to claim 1, wherein the target uplink transmission comprises any one of the following:
physical uplink shared channel PUSCH transmission, physical uplink control channel PUCCH transmission, sounding reference signal SRS transmission, or physical random access channel PRACH transmission.

5. The method according to claim 1, wherein in a case that the target uplink power parameter comprises a downlink reference signal used to estimate a path loss, different values of the target information are associated with different downlink reference signals, and the determining, by a terminal, a target uplink power parameter of target uplink transmission based on target information of the target uplink transmission comprises:
determining, by the terminal based on an association relationship between the target information and the downlink reference signal, a target downlink reference signal associated with the target information of the target uplink transmission, wherein
the target downlink reference signal is a path loss parameter in the target uplink power parameter.

6. The method according to claim 5, wherein the association relationship is protocol-stipulated or configured by a network side device.

7. The method according to claim 5, wherein the downlink reference signal comprises at least one of the following: a synchronization signal block SSB, a channel state information reference signal CSI-RS, or a downlink reference signal associated with an SRS.

8. The method according to claim 1, the determining, by a terminal, a target uplink power parameter of target uplink transmission based on target information of the target uplink transmission comprises:
receiving, by the terminal, an uplink power parameter from a network side device; and
determining, by the terminal based on the target information of the target uplink transmission, the target uplink power parameter, in the uplink power parameter, that corresponds to the target uplink transmission.

9. The method according to claim 8, wherein in a case that the target uplink power parameter comprises a downlink reference signal used to estimate a path loss, before the receiving, by the terminal, an uplink power parameter from a network side device, the method further comprises:
receiving, by the terminal, indication information from the network side device, wherein the indication information is used to indicate a resource of the downlink reference signal and the target information corresponding to the resource of the downlink reference signal.

10. The method according to claim 9, wherein the indication information is carried by group common downlink control information DCI or scheduling DCI.

11. The method according to claim 9, wherein the indication information is used for any one of the following:
the target uplink transmission in a target period;
the target uplink transmission in a next period of a target period;
the target uplink transmission in a target period and at least one period after the target period; or
the target uplink transmission in at least one period after a target period, wherein
the target period is a period in which a moment at which the indication information is received is located.

12. The method according to claim 1, wherein in a case that the target uplink transmission comprises transmission of a random access message, the determining, by a terminal, a target uplink power parameter of target uplink transmission based on target information of the target uplink transmission comprises:
determining, by the terminal based on the target information of the target uplink transmission, whether to perform a power ramping operation based on the target information of the target uplink transmission; and
in a case that it is determined that the power ramping operation is performed based on the target information of the target uplink transmission, determining, by the terminal, the target uplink power parameter of the target uplink transmission based on the target information of the target uplink transmission.

13. The method according to claim 1, wherein the determining, by the terminal, an uplink transmit power of the target uplink transmission based on the target uplink power parameter comprises:
determining, by the terminal, the uplink transmit power of the target uplink transmission based on the target uplink power parameter and a power offset configured by a network side device.

14. The method according to claim 1, wherein the target uplink power parameter comprises at least one of the following power control parameters:
a target received power of the network side device;
a path loss parameter, wherein the path loss parameter comprises a downlink reference signal;
a power control loop;
a transmit power control command;
a power compensation factor; or
a power ramping step.

15. An uplink transmission transmit power determining method, comprising:
sending, by a network side device, an association relationship between target information and a downlink reference signal to a terminal, or sending, by a network side device, an uplink power parameter to a terminal, wherein
the association relationship is used to determine a target power control parameter associated with target information of target uplink transmission, the uplink power parameter comprises the target power control parameter associated with the target information of the target uplink transmission, and the target power control parameter is used to determine an uplink transmit power of the target uplink transmission.

16. The method according to claim 15, wherein a target spatial characteristic corresponding to a target uplink power parameter is determined based on the target information of the target uplink transmission.

17. The method according to claim 16, wherein the target spatial characteristic comprises at least one of the following:
an associated synchronization signal block;
an associated channel state information reference signal;
an associated sounding reference signal;
a spatial relationship; or
transmission configuration indication state or quasi-co-location.

18. The method according to claim 15, wherein the target uplink transmission comprises any one of the following:
physical uplink shared channel PUSCH transmission, physical uplink control channel PUCCH transmission, sounding reference signal SRS transmission, or physical random access channel PRACH transmission.

19. A terminal, comprising a processor and a memory, wherein the memory stores a program or an instruction that can be run on the processor, and when the program or the instruction is executed by the processor, an uplink transmission transmit power determining method, the method comprising:
determining a target uplink power parameter of target uplink transmission based on target information of the target uplink transmission; and
determining an uplink transmit power of the target uplink transmission based on the target uplink power parameter, wherein
the target information comprises at least one of the following:
a slot format;
a slot type; or
subband full duplex configuration information or subband full duplex indication information.

20. A network side device, comprising a processor and a memory, wherein the memory stores a program or an instruction that can be run on the processor, and when the program or the instruction is executed by the processor, steps of the uplink transmission transmit power determining method according to claim 15 are implemented.
